(19) United States
(12) Patent Application Publication
(10) Pub. No.: US 2013/0063745 A1
(43) Pub. Date: Mar. 14, 2013

(54) GENERATING A PAGE OF AN ELECTRONIC DOCUMENT USING A MULTIFUNCTION PRINTER

(71) Applicants: Kirk Steven Tecu, Longmont, CO (US); Mabry Frazier Dozier, III, Lafayette, CO (US)

(72) Inventors: Kirk Steven Tecu, Longmont, CO (US); Mabry Frazier Dozier, III, Lafayette, CO (US)

(73) Assignee: KONICA MINOLTA LABORATORY U.S.A., INC., San Mateo, CA (US)

(21) Appl. No.: 13/232,904

(22) Filed: Sep. 14, 2011

(51) Int. Cl. G06F 3/12

(52) U.S. Cl. 358/1.13

(57) ABSTRACT

A method for generating a page of an electronic document (ED). The method includes: receiving, by a multifunction printer (MFP), a print job having the ED; identifying, by the MFP and after receiving the print job, a location in the ED for placing an item; prompting, by the MFP and after receiving the print job, a user for the item; obtaining, by the MFP and after receiving the print job, the item from an input device operated by the user; and printing, by the MFP and based on the print job, the page by placing the item at the location.

### BACKGROUND

A multifunction printer (MFP) is a machine which incorporates the functionality of multiple devices in one, so as to have a smaller footprint. MFPs typically provide centralized document management, distribution, and production in small and large business settings. A typical MFP may act as a combination of a printer, a scanner, a photocopier, a fax, and an email device.

A MFP may be used by a separate computing device (e.g., a personal computer) to both acquire a scanned image and print an electronic document (ED) including the scanned image. Specifically, the scanner component of the MFP may capture and send the scanned image to the computing device, where the computing device may insert the scanned image into the ED, and then issue a print job including the ED and scanned image to the MFP. Despite the redundant transmission of data back and forth between the computing device and the MFP, users still use the MFP for scanning and printing.

### SUMMARY

In general, in one aspect, the invention relates to a method for generating a page of an electronic document (ED). The method comprises: receiving, by a multifunction printer (MFP), a print job comprising the ED; identifying, by the MFP and after receiving the print job, a location in the ED for placing an item; prompting, by the MFP and after receiving the print job, a user for the item; obtaining, by the MFP and after receiving the print job, the item from an input device operated by the user; and printing, by the MFP and based on the print job, the page by placing the item at the location.

In general, in one aspect, the invention relates to a system for generating a page of an electronic document (ED). The system comprises: a processor; a queue for storing a print job comprising the ED; a parsing module executing on the processor and configured to identify a location in the ED for placing an item after the print job is issued; an input device for obtaining the item from a user after the print job is issued; and a layout engine executing on the processor and configured to print the page by placing the item at the location after the print job is issued.

In general, in one aspect, the invention relates to a non-transitory computer readable medium storing instructions for generating a page of an electronic document (ED). The instructions comprise functionality to: receive a print job comprising the ED; identify, after receiving the print job, a location in the ED for placing an item; prompt, after receiving the print job, a user for the item; obtain, after receiving the print job, the item from an input device operated by the user; and print, based on the print job, the page by placing the item at the location.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIG. 3 shows an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for generating a page of an ED. Specifically, a MFP may receive, from a computing device, a print job including an ED with one or more locations for placing items. The items are not included in the print job. Instead the items must be obtained from the user after the print job is received by the MFP. Once the items are collected, one or more pages of the ED may be generated by placing the items at the specified locations.

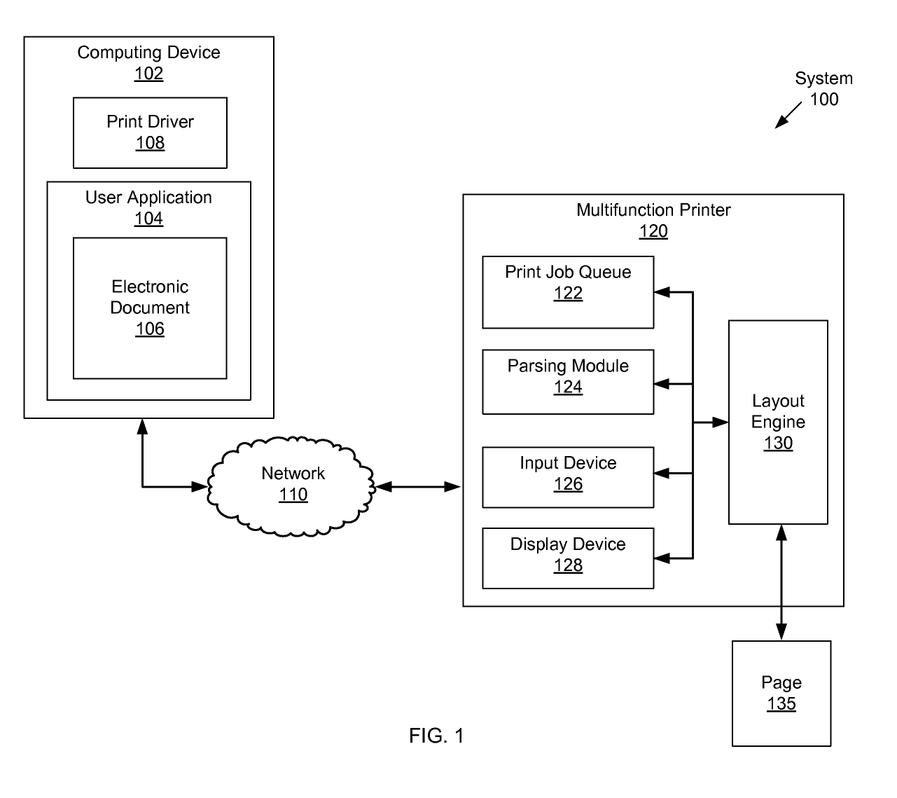

FIG. 1 shows a system (100) in accordance with one or more embodiments of the invention. As shown in FIG. 1, the system (100) includes components such as a computing device (102) and a MFP (120) connected via a network (110) with wired and/or wireless segments. The computing device (102) may correspond to a server, a mainframe, a desktop Personal Computer (PC), a laptop, a Personal Digital Assistant (PDA), a telephone, a smart phone, a kiosk, a cable box, and any other hardware device.

In one or more embodiments of the invention, the computing device (102) executes the user application (104). The user application (104) is a software application operated by a user and configured to obtain, input, generate, display, and/or print an ED (e.g., Electronic Document (106)) having any number of pages. Accordingly, the user application (104) may be a word processor, slide presentation software, spreadsheet software, graphics software, video editor, and so forth. The ED (106) may be a report or form and may be saved in any format including portable document format (PDF) and Office Open XML (OOXML).

In one or more embodiments of the invention, the computing device (102) executes the print driver (108) to generate a print job. The printer driver (108) is software configured to convert the data in the ED (106) to a specific format required by the MFP (120). For example, in the case of page descriptor language (PDL) printing schemes, the printer driver (108) generates a print job described in PDL based on the document contents. The PDL commands/instructions include various print objects (e.g., text objects, graphic objects, image objects) and control objects (e.g., blend and transparency commands, color management information) to describe the ED (106) for printing. The printer (e.g., MFP (120)) interprets the PDL commands/instructions to generate page images (i.e., the printer rasterizes the objects). As another example, in the case of raster printing, the printer driver (108) generates page images (i.e., rasterized image data such as bitmap data) based on the document content and the printing options, and sends the page images to the printer.

In one or more embodiments of the invention, the ED (106) includes empty spaces (i.e., locations) for the placement of one or more items. An item corresponds to an element that is visible in the hardcopy page (135) generated from the print job, but is not present in the print job sent to the MFP (120) and must be obtained from a user of the MFP (120) after the print job is received by the MFP (120). Example items include scanned fingerprints, signatures, clipart, photographs, scanned licenses, scanned social security cards, etc.

In one or more embodiments of the invention, the ED in a print job includes a placeholder at the location and/or denoting the location of the item. The placeholder may include a unique identifier (UID), specify a size of the item, and/or specify a type of the item (e.g., signature, thumbprint, license, photograph, etc.). When the ED in the print job is represented/defined using a document markup language, the placeholder may be specified in a tag. In the case of PDL printing schemes, the placeholder may be specified as a PDL command or a PDL object. In the case of raster printing, the placeholder may be present within a page image. Those skilled in the art, having the benefit of this detailed description, will appreciate that the PDL instructions/commands and/or the page images may deliberately leave/reserve white space at the location to be occupied by the item. Further, those skilled in the art, having the benefit of this detailed description, will also appreciate that the location may be specified in absolute (i.e., coordinates) or relative (i.e., with respect to other ED elements) terms. In one or more embodiments of the invention, the print ticket in the print job may specify the page and coordinates on the page where the item is to be placed.

In one or more embodiments of the invention, the MFP (120) includes a print job queue (122). The print job queue (122) is configured to store (i.e., buffer) one or more received print jobs. The print job queue (122) may also be configured to sort or rank (i.e., prioritize) the stored print jobs. As discussed above, a print job is a request by the computing device (102) to print an ED (106) using the MFP (120). The print job may include the ED (106) as well as any options for printing the ED (106) including a unique identifier, a source IP address, a destination IP address, a media size, a number of copies, and a priority level associated with the ED (106).

In one or more embodiments of the invention, the MFP (120) includes a parsing module (124). The parsing module (124) is configured to identify the location(s) in the ED of the print job for placing the items. Specifically, the parsing module (124) is configured to parse the print job to identify the placeholders corresponding to the items. As discussed above, the placeholders may identify the types and sizes of the items to be placed at the locations. As also discussed above, the placeholders may be positioned at the locations and/or denote the locations of the items in the ED.

In one or more embodiments of the invention, the MFP (120) includes one or more input devices (e.g., input device (126)). The input devices are configured to obtain the item(s) from a user. The item(s) may be, for example, a fingerprint, a driver's license, or a signature of the user. The item(s) may also be a file or an image. The input device (126) may be, for instance, a scanner or a touchscreen capable of capturing user input. The input device (126) may also be a flash drive capable of storing an image. Although only a single input device (126) is shown in FIG. 1, those skilled in the art, having the benefit of this detailed description, will appreciate that the MFP (120) may have any number of input devices. Moreover, the MFP (120) may identify the input device needed to capture the item based on the item's type.

In one or more embodiments of the invention, the MFP (120) includes a display device (128) (e.g., a console panel). The display device (128) is configured to display a prompt to a user for an item in the print job received by the MFP (120). The language of the prompt may instruct the user as to which input device is needed to capture the item. For example, the prompt may state “Please sign on the touchpad” when the item is a signature and the input device to capture the item is a touchpad. The prompt may be a visual and/or an audio prompt. The display device (128) may also display the ED with the item at the location after the item is obtained/acquired from the input device (126) (discussed below).

In one or more embodiments of the invention, the MFP (120) includes a layout engine (130). The layout engine (130) is configured to generate the page (135) by placing the item at the location. For example, the layout engine (130) may replace the placeholder with the corresponding item and scale the item to the size specified by the placeholder. In the case of PDL printing schemes, the layout engine (130) may interpret the incoming PDL commands in order to generate page images (i.e., the printer rasterizes the objects) including the item(s). In the case of EDs described/represented using a document markup language (e.g., OOXML), the layout engine (130) may calculate the page positions of all elements on the pages including the item(s). In other words, the layout engine (130) may execute a layout of the ED (106) with the item(s).

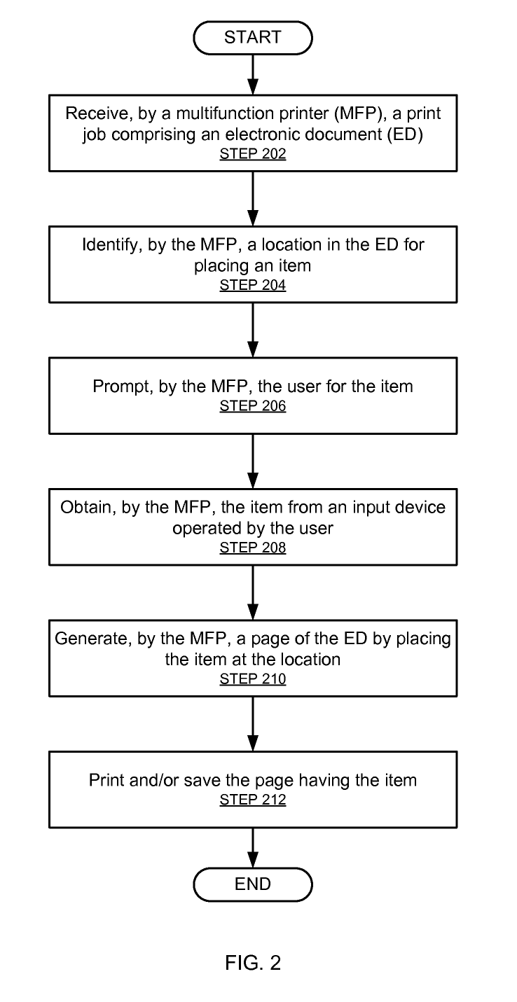

FIG. 2 shows a flowchart in accordance with one or more embodiments of the invention. The process shown in FIG. 2 may be used, for example, with the components of system (100) (e.g., MFP (120), discussed above in reference to FIG. 1) to generate a page of an ED. One or more steps shown in FIG. 2 may be omitted, repeated, and/or performed in a different order among different embodiments of the invention. Accordingly, embodiments of the invention should not be considered limited to the specific number and arrangement of steps shown in FIG. 2.

In STEP 202, a print job including an ED is received by a MFP. The ED may be represented/defined using a document markup language (e.g., ODF, OOXML, etc.). Accordingly, the objects (e.g., text characters, symbols, graphical objects) and the properties (e.g., spacing, fonts, font sizes, etc.) of the ED may be recorded as attributes within the tags of the document markup language. Alternatively, in the case of PDL printing schemes, the ED in the print job may be described using PDL commands/instructions including various print objects (e.g., text objects, graphic objects, image objects) and control objects (e.g., blend and transparency commands, color management information). As yet another alternative, in the case of raster printing, the ED in the print job may correspond to one or more page images (i.e., rasterized image data such as bitmap data) based on the document content and the printing options. In one or more embodiments of the invention, the print job also includes a print ticket specifying the printing options (e.g., number of copies, two-sided printing, input bin (i.e., paper tray), priority, etc.)

In STEP 204, after the print job has been received, a location in the ED for placing an item is identified. As discussed above, the item corresponds to an element that is visible in the hardcopy document generated from the print job, but is not present in the received print job and must be obtained from a user of the MFP after the print job is received. In one or more embodiments of the invention, the location is identified by parsing the ED in the print job. Specifically, the ED includes a placeholder at the location and/or denoting the location of the item. The placeholder may include a unique identifier (UID), specify a size of the item, and/or specify a type of the item (e.g., signature, thumbprint, license, photograph, etc.). When the ED is represented/defined using a document markup language, the placeholder may be specified in a tag. In the case of PDL printing schemes, the placeholder may be specified as a PDL command or a PDL object. In the case of raster printing, the placeholder may be present within a page image. Those skilled in the art, having the benefit of this detailed description, will appreciate that the PDL instructions/commands and/or the page images may deliberately leave/reserve white space at the location to be occupied by the item. Further, those skilled in the art, having the benefit of this detailed description, will also appreciate that the location may be specified in absolute (i.e., coordinates) or relative (i.e., with respect to other ED elements) terms. In one or more embodiments of the invention, the location is identified by parsing the print ticket in the print job. The print ticket may specify the page and coordinates on the page where the item is to be placed.

In STEP 206, after the print job is received and the location in the ED for placing the item is identified, the MFP prompts the user for the item. As discussed above, the placeholder may specify the type of the item. Accordingly, the prompt displayed on the MFP to the user may be based on the type. Moreover, the MFP may identify the input device needed to obtain/capture the item based on the type. For example, if the item is a fingerprint, the MFP identifies the biometric scanner as the input device needed to capture the item, and prompts the user to place his/her finger on the biometric scanner. As another example, if the item is a signature, the MFP identifies a touchpad as the input device needed to capture the item, and prompts the user to sign on the touchpad. As a further example, if the item is clipart or a photograph, the MFP identifies the universal serial bus (USB) port as the input device, and the user is prompted to insert a flash drive.

In STEP 208, the item is obtained from the input device operated by the user. In STEP 210, a page of the ED is generated by placing the item at the location. Specifically, the item and the portions of the ED surrounding the item may be placed on a page by a layout engine during a layout of the ED. As discussed above, the placeholder may specify a size of the item. It may be necessary to scale the item obtained from the input device to match the specified dimensions.

In STEP 212, the page with the item at the location is printed and/or saved.

In other words, the MFP may print (i.e. generate a physical/hard copy of) the ED with the item (e.g. the signature) at the location. The MFP may also store the ED with the item at the location, email the ED with the item at the location, and/or display the ED with the item at the location on a console panel of the MFP.

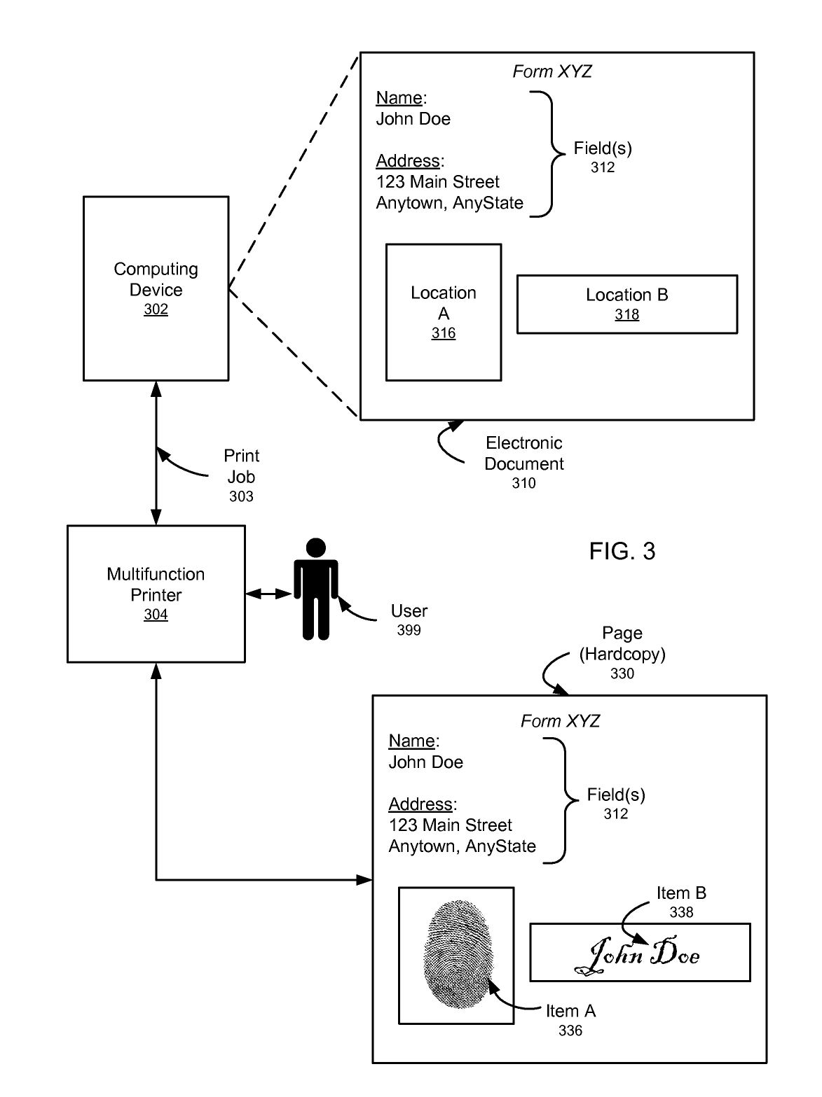

FIG. 3 shows an example in accordance with one or more embodiments of the invention. As shown in FIG. 3, a user (399) operates the MFP (304). The MFP (304) receives a print job (303) from a computing device (302). The computing device (302) may be located at a different physical location than the user (399) and/or the MFP (304), and the print job (303) may be received by the MFP (304) over a network. The print job (303) includes an ED (310) corresponding to a form (e.g. “form XYZ”) with multiple fields (312). For instance, form XYZ may be a driver's license application issued by a DMV, and may include the name of an applicant (e.g. “John Doe”), and the address of the applicant (e.g. “123 Main Street, Anytown, AnyState”). The ED (310) may also include multiple locations (e.g., location A (316) and location B (318)) for placing items. As discussed above, an item corresponds to an element that is visible in the hardcopy document generated from the print job (303), but is not present in the received print job (303) and must be obtained from the user (399) of the MFP (304) after the print job (303) is received. The multiple locations (316, 318) may be denoted in the ED (310) with placeholders specifying the type(s) of items to be placed at the locations (316, 318).

When the print job (303) is received by the MFP (304), the ED (310) is parsed and the locations (316, 318) in the ED (310) are identified (i.e., the placeholders are encountered during the parsing). The MFP (304) identifies, based on the type(s) of the items, the input devices (e.g., biometric scanner, touchpad) needed to capture/acquire the items from the user (399). Further, the MFP (304) may prompt the user (399), using the display device of the MFP (304), to submit the items using the input devices. As shown in FIG. 3, Location A (316) is for Item A (336), while Location B (318) is for Item B (338). As also shown in FIG. 3, Item A (336) corresponds to a fingerprint, while Item B (338) corresponds to a signature. Accordingly, the MFP (304) prompts the user to submit a thumbprint using a biometric scanner, and the MFP (304) prompts the user (399) to submit a signature using a touchpad. Once the user (399) has provided these items (i.e., Item A (336) and Item B (338)), the multifunction printer (304) may incorporate them into the ED (310), and either save the ED (310) including these items to a network location, email the ED (310) including these items to a recipient, or generate a hardcopy page (330) including the items. In other words, the page (330) will have the same fields (312) that previously existed in the electronic document (310), but will also have the items A (336) and B (338) provided by the user (399). Using the DMV form example, after the user (399) has submitted his or her signature and fingerprint, the DMV may then process the form XYZ with the user's complete information. Those skilled in the art will appreciate that this system may expedite the process of collecting user information in order to complete EDs.

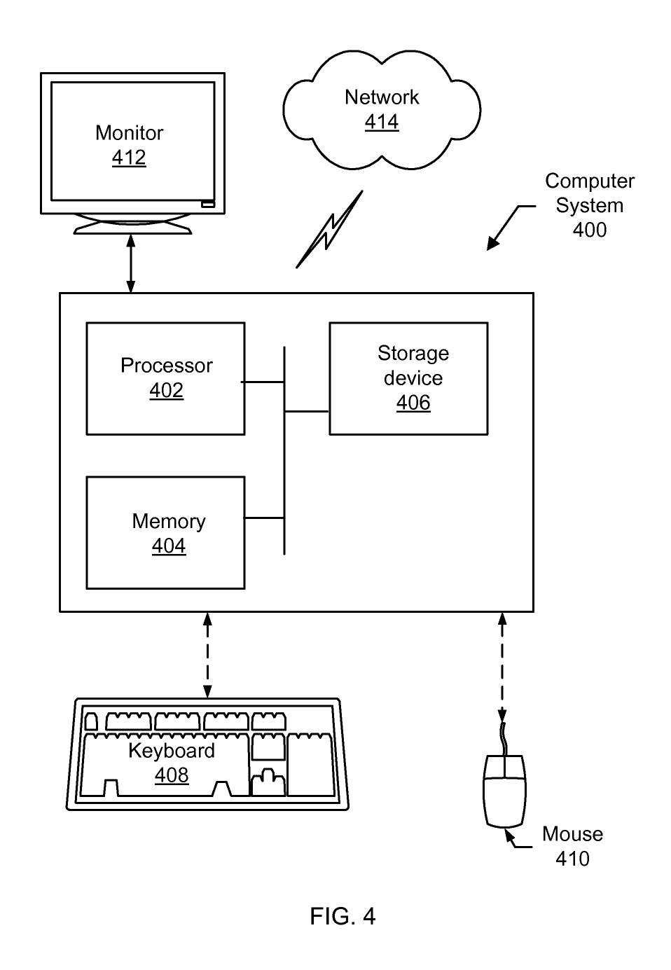

Embodiments of the invention may be implemented on virtually any type of computer regardless of the platform being used. For example, as shown in FIG. 4, a computer system (400) includes one or more processor(s) (402), an associated memory (404) (e.g. random access memory (RAM), cache memory, flash memory, etc.), a storage device (406) (e.g. a hard disk, an optical drive such as a compact disk drive or digital video disk (DVD) drive, a flash memory stick, etc.), and numerous other elements and functionalities typical of today's computers (not shown). In one or more embodiments of the invention, the processor (402) is hardware. For example, the processor may be an integrated circuit. The computer system (400) may also include input means, such as a keyboard (408), a mouse (410), or a microphone (not shown). Further, the computer system (400) may include output means, such as a monitor (412) (e.g. a liquid crystal display (LCD), a plasma display, or cathode ray tube (CRT) monitor). The computer system (400) may be connected to a network (414) (e.g. a local area network (LAN), a wide area network (WAN) such as the Internet, or any other type of network) via a network interface connection (not shown). In one or more embodiments of the invention, many different types of computer systems exist, and the aforementioned input and output means may take other forms. Generally speaking, the computer system (400) includes at least the minimal processing, input, and/or output means necessary to practice embodiments of the invention.

Further, in one or more embodiments of the invention, one or more elements of the aforementioned computer system (400) may be located at a remote location and connected to the other elements over a network. Further, embodiments of the invention may be implemented on a distributed system having a plurality of nodes, where each portion of the invention (e.g. the computing device, the multifunction printer) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, a tape, memory, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating a page of an electronic document (ED), comprising:
receiving, by a multifunction printer (MFP), a print job comprising the ED;
identifying, by the MFP and after receiving the print job, a location in the ED for placing an item;
prompting, by the MFP and after receiving the print job, a user for the item;
obtaining, by the MFP and after receiving the print job, the item from an input device operated by the user; and
printing, by the MFP and based on the print job, the page by placing the item at the location.

2. The method of claim 1, wherein identifying the location comprises:
parsing a print ticket in the print job specifying the location for the item.

3. The method of claim 1, wherein identifying the location comprises:
initiating, by the MFP, a parsing of the ED; and
identifying, by the MFP and during the parsing, a placeholder at the location specifying the item.

4. The method of claim 3, wherein the ED is an Office Open XML (OOXML) document, and wherein the location is described using a tag within the OOXML document.

5. The method of claim 3, wherein the ED comprises a plurality of page description language (PDL) commands and objects, and wherein the placeholder comprises a unique identifier (UID).

6. The method of claim 3, wherein the placeholder describes a size of the item, and wherein generating the page comprises scaling the item to the size.

7. The method of claim 1, further comprising:
executing, by the MFP, at least one selected from a group consisting of storing the page comprising the item, emailing the page comprising the item, and displaying the page comprising the item on a display device.

8. The method of claim 1, wherein the ED is a form, wherein the input device is a scanner, and wherein the item is at least one selected from a group consisting of a signature, a thumbprint, and a license.

9. The method of claim 1, wherein the input device is a flash drive, and wherein the item is an image.

10. A non-transitory computer readable storage medium storing instructions to generate a page of an electronic document (ED), the instructions comprising functionality to:
receive a print job comprising the ED;
identify, after receiving the print job, a location in the ED for placing an item;
prompt, after receiving the print job, a user for the item;
obtain, after receiving the print job, the item from an input device operated by the user; and
print, based on the print job, the page by placing the item at the location.

11. The non-transitory computer readable storage medium of claim 10, wherein the instructions to identify the location comprise functionality to:
parse a print ticket in the print job specifying the location for the item.

12. The non-transitory computer readable storage medium of claim 10, wherein the instructions to identify the location comprise functionality to:
initiate a parsing of the ED; and
identify, during the parsing, a placeholder at the location specifying the item.

13. The non-transitory computer readable storage medium of claim 10, wherein the placeholder specifies a size, and wherein the instructions to generate the page comprising functionality to scale the item to the size.

14. The non-transitory computer readable storage medium of claim 10, wherein the ED is a form, wherein the input device is a scanner, and wherein the item is an image from the scanner.

15. The non-transitory computer readable storage medium of claim 10, wherein the device is a flash drive.

16. A system for generating a page of an electronic document (ED), comprising:
a processor;
a queue for storing a print job comprising the ED;
a parsing module executing on the processor and configured to identify a location in the ED for placing an item after the print job is issued;
an input device for obtaining the item from a user after the print job is issued; and
a layout engine executing on the processor and configured to print the page by placing the item at the location after the print job is issued.

17. The system of claim 16, further comprising:
a display device for displaying a prompt to the user for the item after the print job is issued.

18. The system of claim 16, further comprising:
a multifunction printer (MFP) comprising the queue, the parsing module, and the layout engine; and
a computing device external to the MFP and configured to issue the print job comprising the ED.

19. The system of claim 16, wherein the parsing engine is further configured to identify a placeholder at the location specifying the item, and wherein the layout engine is further configure to execute a layout of the ED with the item.

20. The system of claim 16, wherein the input device is a scanner, wherein the ED is a form, and wherein the item comprises at least one selected from a group consisting of a signature, a thumbprint, and a license.
